(19) United States
(12) Patent Application Publication
(10) Pub. No.: US 2014/0055056 A1
(43) Pub. Date: Feb. 27, 2014

(54) TECHNOLOGY TO DESENSITIZE LED LAMPS AGAINST POWER RIPPLES

(71) Applicant: LT LIGHTING (TAIWAN) CORP., Hsinchu (TW)

(72) Inventors: Geoffrey Wen-Tai Shuy, Taipei City (TW); Chang-Horang Li, Hsinchu City (TW); Hsin-Chen Lai, Taichung City (TW); Wen Ten Chang, Kaohsiung City (TW)

(21) Appl. No.: 14/068,934

(22) Filed: Oct. 31, 2013

(51) Int. Cl. H05B 33/08

(52) U.S. Cl. CPC H05B 33/0803
USPC 315/291

(57) ABSTRACT

An LED lamp having an operating voltage range within which if the supply voltage is provided within the operating voltage range, the LED lamp produces light in a designed light range, and which has reduced sensitization to ripples. The LED lamp includes a network of passive elements that are structured such that the I-V characteristic curve has a plateau region within the operating voltage range. For instance, a maximum slope of an I-V characteristic curve of the network is shallower within the operating voltage range than the maximum slope of an I-V characteristic curve of the network below the operating voltage range.

### BACKGROUND

Conventional LED lamps are very sensitive to power voltage ripples. In operation, LED lamps may be subject to terminal voltage fluctuations due to ripples provided by the power supply; thereby inducing a flickering phenomenon in which the LED lamp light emissions flicker. There are two ways to reduce such a flickering phenomenon. First, very strict ripple suppression circuitry or “constant current” circuitry may be incorporated within the power supply. Alternatively, feedback circuitry may be built into the LED lamps to maintain stable lighting.

Conventional approaches of flickering suppression focus on either 1) conditioning the supplied power quality to reduce the terminal voltage ripples, or 2) regulating the supply current through feed-back control circuitry to reduce fluctuation in the current flow through the LED lamps. Thus, these conventional approaches are hereinafter referred to as “supply-side flickering suppression”.

### BRIEF SUMMARY

Embodiments described herein aim at developing a technology to cost effectively desensitize LED lamps toward ripples without extra power consumption; and to derive design rules such that the lamps become much less sensitive to the voltage fluctuations due to ripples passing down from the power supplies.

The principles and design rules described herein result in designs for mass-producable ripple-insensitive LED lamps. The embodiments show that LED lamps designed in according with the disclosed principles are insensitive to the power ripples even without extra power consumption. They produce reduced or no flickering phenomena under the ripple conditions that would cause conventional LED lamps to have significant flickering. At least some, and potentially all, of these embodiments do not consume extra power and also can be cost effectively mass produced.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates typical I-V characteristics of two types of LED lamp prototypes in Group-A and Group-B respectively, with reference to their typical operating voltage range between Vb and Vb′;

FIG. 2 illustrates I-V characteristics of example LED lamp prototypes modified from group-B, called group-B′, in accordance with the principles described herein, with reference to their operating voltages within a plateau region (between Vb and Vb′) to thereby have high enough current with high ripple tolerance; and

FIG. 3 illustrates a circuit diagram of a lighting assembly that produces the I-V characteristics shown in FIG. 2.

### DETAILED DESCRIPTION

This patent disclosure reveals principles and embodiments of novel and inexpensive designs for LED lamps that can increase LED lamp tolerance to terminal voltage fluctuations due to power supply ripples. When powered by the same power supply with ripples (hereinafter “rippled power supply”), conventional LED lamps have severe flickering, while the embodiments described herein have significantly reduced flickering, or even no noticeable flickering.

Conventional LED lamps are very sensitive to power voltage ripples. At their operating point, when the LED lamps are subject to terminal voltage fluctuations induced by power supply ripples, conventional LED lamps produce severe flickering. To suppress the flickering of the conventional LED lamps, the power supply may either be equipped with very strict ripple suppression circuitry or constant current output circuitry. Alternatively, there may be feedback control circuitry built into the LED lamps to stabilize light emissions.

These conventional approaches of flickering suppression focus on either 1) conditioning the supplied power quality to reduce terminal voltage fluctuations or 2) regulating the supply current via feed-back control circuitry for restricting the current fluctuations from passing through the LED lamps. Thus, these conventional approaches are referred to herein as “supply-side flickering suppression”. In contrast, the approach for flicker suppression disclosed herein will be called “demand-side ripple desensitization” or “desensitization against ripples”. The circuits used in the supply-side flickering suppression approaches consume extra power and also induce extra costs, while at least some embodiments of the demand-side approach do not.

Shuy et. al. invented and patented LED lamp powering technologies, published on Aug. 9, 2012 as United States Patent Publication No. 2012/0200235A1 and issued as U.S. Pat. No. 8,525,441 on Sep. 3, 2013 (submitted herein as a reference). The patented technologies can regulate power consumption of LED lamps. The patented technologies include using networks of LEDs and passive electrical elements to regulate the power consumption of the LED lamps. This demand-side approach can result in designs for the LED lamps to increase efficacy when terminal voltage and/or power consumption are decreased within the designed range.

In one embodiment, steps to come up with an approach to desensitize the LED lamps against powering ripples can be described as follows:

Step (I): Design multiple networks of passive elements, and build a prototype for each design.

Step (II): Measure all the prototypes to and construct a corresponding characteristic file associate with each prototype. Each file includes the I-V characteristics and the L-P characteristics of each corresponding prototype.

Step (III): Design and build a special power supply that can add known voltage-ripples to power these prototypes. Observe the resulting flickering when the special power supply is applied to the prototype. The observed flickering is compared with the degree of flickering from a set of purchased conventional LED lamps that are powered by the same special power supply.

Step (IV): Categorize the prototypes into three groups; group A, group B and group C. The prototypes in group-A are those prototypes that have noticeably higher tolerance against the voltage-ripples as compared to the conventional LED lamps. For instance, some or even perhaps all of the prototypes in group A have no noticeable flickering while the conventional LED lamps have serious flickering. In contrast, group-B is to include those prototypes that have no noticeable difference in flickering tolerance when compared with the conventional LED lamps. Group-C is to include prototypes that have some degree of flickering behavior between the group-A and group-B.

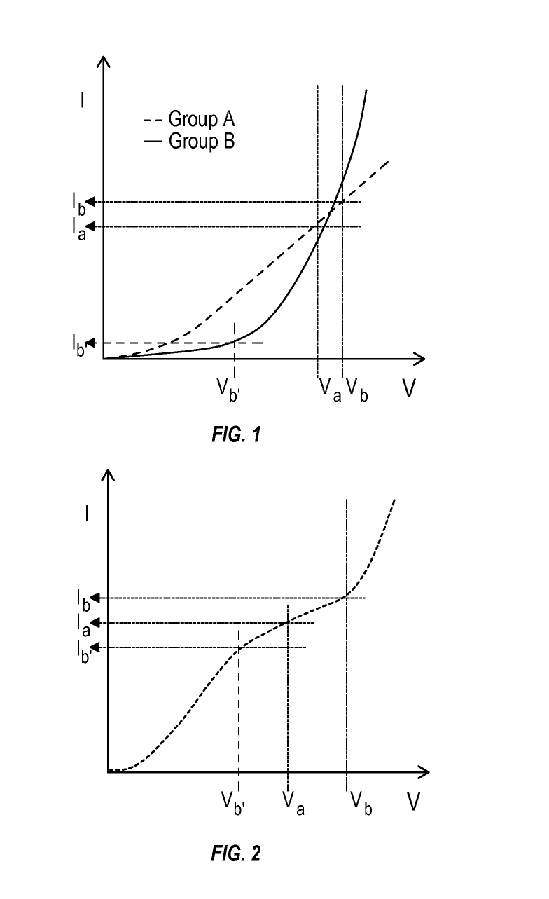

Step (V): Examine the I-V characteristics of the group-A and compare with that of group-B. The inventors found that, within the operating voltages of those prototypes in group-B, the corresponding I-V characteristics showed a steep-sloped within the operating voltage (that is, a given change in voltage resulted in a larger change in current). A typical I-V characteristic of group-B is shown abstractly in FIG. 1. In contrast, the I-V characteristics of the prototypes of group A within the operating voltages show a relatively slighter slope (that is, a given change in voltage resulted in a smaller change in current) A typical I-V characteristic of group-A is also shown abstractly in FIG. 1. Furthermore, when measuring and examining the I-V characteristics of the conventional LED lamps, the conventional LED lamps are clearly operating at a very steep slope of the corresponding I-V characteristics.

Summarized from the study described above, we formulated a design rule that when LED lamps operate at shallower slope of the corresponding I-V characteristics, the LED lamps have higher tolerance against the voltage fluctuations produced from the powering ripples.

We confirmed this conclusion; by temporarily moving the operating points of the prototypes in group-B to the slow slope region of the corresponding I-V characteristics (below the designed operating voltage range). This resulted in the LED lamps gaining tolerance toward the power ripples provided by the special power supply. The same increased ripple tolerance was also observed for conventional LED lamps when they were made to operate in the region of the shallower slope region of their corresponding I-V characteristics (again being below the designed operating voltage range). However, when so reducing the operating voltage below the designed range, the light output of either conventional LED lamps or prototypes in group B are also much reduced when they are operated at the high ripple tolerant region.

However, the design rule derived from the above five invention steps can be further enhanced to come up with practical LED lamps with high tolerance against ripples. Thus, we proceeded further as follows:

Step (VI): Compare the operating currents of those prototypes in group-A and those in group-B. At their designed operating voltages (such as at “Va” shown in FIG. 1, all prototypes of both group-A and group-B are at high enough current and thus enough light output as illustrated abstractly in FIG. 1; but their tolerances against ripples are very different. When the operating voltages of the prototypes of group-B are adjusted downward to the higher ripple tolerance operating voltages, the corresponding operating currents are reduced significantly; as is the light output.

Although they have high tolerance against ripples at the modified operating voltage, the designs in group-B are not suitable for practical LED lamp designs due to inadequate light-output at the new operating voltages. In accordance with embodiments described herein, the design of an LED lamp produces adequate light output while also having high tolerance against ripples.

Step (VII): Abstractly redesign an I-V characteristic for prototypes in group-B; such that the lamps would provide both adequate lighting and also tolerate large ripples. In other words, the LED lamp is designed to have its operating voltage at a region having very shallow slope I-V characteristic, and also having enough current to produce enough light output.

To reiterate, the I-V characteristic of a desirable LED lamp have a “plateau region” having high enough current; and then operate the lamp at the voltage within the plateau region. This I-V characteristic is abstractly illustrated in FIG. 2 shown for the modified design described above.

In this description and in the claims, the I-V characteristic curve has a plateau region if the following two conditions are true: 1) the maximum slope of the I-V characteristic curve is smaller within the operating voltage range than the maximum slope of the I-V characteristic curve below the operating voltage range; and 2) the maximum slope of the I-V characteristic curve increases at a greater slope (than the maximum slope within the operating voltage range) for at least some of the increased voltage before a peak current is reached. As an example, in the case of the first condition, the maximum slope of the I-V characteristic curve within the operating voltage range may be less than 90 percent, 80 percent, 70 percent, 60 percent, 50 percent, 40 percent, or even 30 percent, of the maximum slope of the I-V characteristic curve below the operating voltage range. The smaller the percentage, the less the flickering.

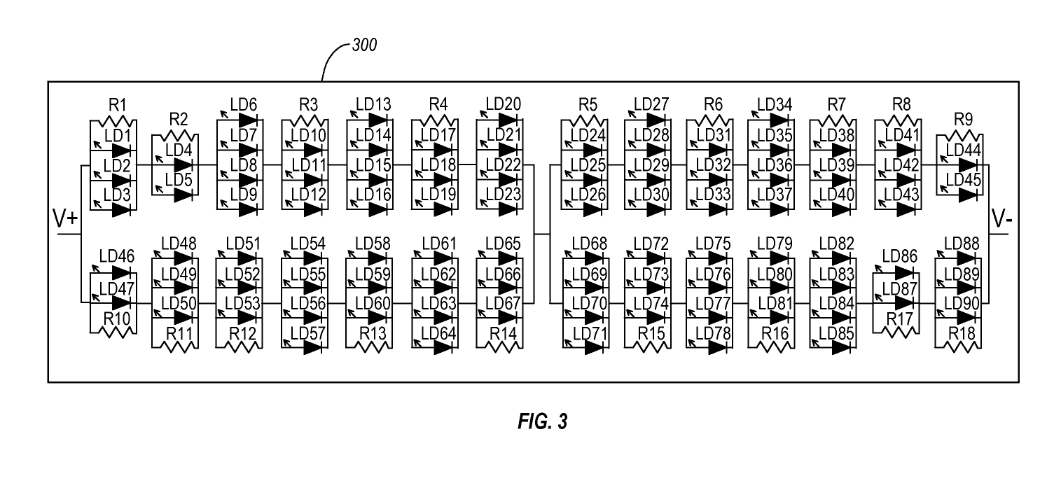

Step (VIII): Follow the principles disclosed in the patented LED powering technologies (Pub. No.: US2012/0200235A1) to come up a desirable network of LED and passive electrical components. This network exhibits the desired I-V characteristics stated in step (VII). We then build a prototype with the network. As an example, FIG. 3 depicts a circuit of passive network 300 resulted from the exercising this step that may produce a plateau region illustrated in FIG. 2. The passive network 300 includes multiple passive components including a combination of LED diodes and resistors. As shown in FIG. 3, a circuit of lighting assembly consists of 90 LED (labeled LD1 through LD90) and 18 resistors (labeled R1 through R18) which are networked into 4 sub-groups, two sub-groups coupled in parallel into 2 groups. The two groups are then coupled in series between two terminals V+ and V− of a power supply; as shown in FIG. 3.

Step (IX): Measure the relevant characteristics including the I-V, the L-P, and the flickering characteristics. We found that when the prototype operates at its designed operating voltage in the plateau region; it produces adequate lighting and also having very high tolerance against ripples. This step proves the principles derived above are fundamentally correct.

Step (X): To verify the ubiquity of the principles derived from Steps (VI), (VII), and (VIII), we design additional 8 desired I-V characteristics in according to step (VII); with 8 different operating voltages ranging from 24 to 380 Vdc. We go through the invention steps (VIII) and (IX) and found that all of these designed prototypes have the desired light-output and also the having very high tolerance against ripples without extra power consumption.

As described above, we finished the invention steps that derived the principles and design rules to come up with networks of LED and passive electrical elements. We also verified that these principles and design rules can produce the desired networks.

Incorporate these networks to fabricate LED lamps, one can produce the LED lamps that having very high tolerance against terminal voltage fluctuations due to powering ripples and with adequate light output, as all embodiments described above.

In other words, the LED lamps can be designed to be insensitive to terminal voltage fluctuations induced by the powering ripples. Thus, one can power these LED lamps with much simpler and cost effective power supplies.

To verify the conclusion above, we produce two power supplies that just convert 110 VAC or 220 VAC into DC power with very large ripples. We then drove two suitable LED prototypes produced in the Step (X). We found that they both have desirable light outputs and do not have observable flickering at all, while the conventional LED lamps having severe flickering when driven by these two simple power supplies. Since a ripple-suppressed power supply or power supply equipped with constant current feedback control may cost up to 35% of some conventional LED lamps; the principles described herein can improve the affordability of the LED lamps drastically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An LED lamp having an operating voltage range within which if the supply voltage is provided within the operating voltage range, the LED lamp produces light in a designed light range, the LED lamp comprising:
a network of passive elements that are structured such that a maximum slope of an I-V characteristic curve of the network is shallower within the operating voltage range than the maximum slope of an I-V characteristic curve of the network below the operating voltage range.

2. The LED lamp in accordance with claim 1, wherein the maximum slope of the I-V characteristic curve of the network increases at a greater slope higher than the operating voltage range before the current reaches a maximum.

3. The LED lamp in accordance with claim 1, wherein the I-V characteristic curve has a plateau region within the operating voltage range.

4. The LED lamp in accordance with claim 1, wherein the maximum slope of the I-V characteristic curve within the operating voltage range is less than 90 percent the maximum slope of an I-V characteristic curve of the network below the operating voltage range.

5. The LED lamp in accordance with claim 1, wherein the maximum slope of the I-V characteristic curve within the operating voltage range is less than 80 percent the maximum slope of an I-V characteristic curve of the network below the operating voltage range.

6. The LED lamp in accordance with claim 1, wherein the maximum slope of the I-V characteristic curve within the operating voltage range is less than 70 percent the maximum slope of an I-V characteristic curve of the network below the operating voltage range.

7. The LED lamp in accordance with claim 1, wherein the maximum slope of the I-V characteristic curve within the operating voltage range is less than 60 percent the maximum slope of an I-V characteristic curve of the network below the operating voltage range.

8. The LED lamp in accordance with claim 1, wherein the maximum slope of the I-V characteristic curve within the operating voltage range is less than 50 percent the maximum slope of an I-V characteristic curve of the network below the operating voltage range.

9. The LED lamp in accordance with claim 1, wherein the maximum slope of the I-V characteristic curve within the operating voltage range is less than 40 percent the maximum slope of an I-V characteristic curve of the network below the operating voltage range.
